(19) United States
(12) Patent Application Publication
(10) Pub. No.: US 2023/0173985 A1
(43) Pub. Date: Jun. 8, 2023

(54) RACK SYSTEM FOR A COMMERCIAL VEHICLE AND COMMERCIAL VEHICLE

(71) Applicant: Ford Global Technologies, LLC, Dearborn, MI (US)

(72) Inventors: Jeroen Lem, Wittem (NL); Keith Allen Godin, Dearborn, MI (US); Marcel Grein, Geilenkirchen (DE); Nicole Leonarda Wilhelmina Eikelenberg, Meerssen (NL); Johnathan Andrew Line, Northville, MI (US); Joseph Michael Kish, Canton, MI (US); Jimmy Moua, Canton, MI (US); David Longin, Herent (BE); Detlef Kuck, Inden (DE)

(73) Assignee: Ford Global Technologies, LLC, Dearborn, MI (US)

(21) Appl. No.: 17/988,189

(22) Filed: Nov. 16, 2022

(30) Foreign Application Priority Data
Dec. 2, 2021 (EP) 21211935.8

(51) Int. Cl. B60R 5/00

(52) U.S. Cl. CPC B60R 5/003

(57) ABSTRACT

A rack system for a commercial vehicle including at least one guide rail fixable to at least one vehicle structure of the commercial vehicle within a rear storage compartment of the commercial vehicle. To provide a more efficient way of offering rack space to get a better trade-off between the amount of racks and space for other items, to maximize the utilization rate of the rear storage compartment, the rack system comprises at least two racks slidingly supported by the guide rail back and forth in a lateral or longitudinal direction of the commercial vehicle and arranged in series to each other with respect to the guide rail.

### CROSS-REFERENCE TO RELATED APPLICATION

This application claims foreign priority benefits under 35 U.S.C. § 119(a)-(d) to European Patent Application No. 21211935.8 filed on Dec. 2, 2021, which is hereby incorporated by reference in its entirety.

### FIELD OF THE DISCLOSURE

The present disclosure generally relates to a rack system for a commercial vehicle and a commercial vehicle having a rear storage compartment.

### BACKGROUND OF THE DISCLOSURE

Commercial vehicles can be used by a multitude of users with a very wide range of applications. A lot of the users often place racks in a rear storage compartment of a commercial vehicle to store items, such as parts, tools and parcels, for example, such as a craftsman/handyman, who has a lot of items in the vehicle. Package delivery is another example where rack space is needed for all the packages.

Rack space is useful to maximize load capacity of a commercial vehicle when the user has a lot of (relatively small) items to carry in the commercial vehicle, such as a van. But not all items can be stored in a rack, as they might be too big or too heavy. This leads to a trade-off between the available rack space and space for other items in the commercial vehicle.

Conventionally, the space for racks is limited to the left-side and right-side panels of the rear storage compartment of some commercial vehicles, where on one side usually space is taken away due to a sliding door at this position. This leads to the fact that the commercial vehicle space is not completely occupied and also that the commercial vehicle is still well under its capacity.

It would be desirable to provide a more efficient way of offering rack space to get a better trade-off between the amount of racks and space for other items, to maximize the utilization of a rear storage compartment of a commercial vehicle.

### SUMMARY OF THE DISCLOSURE

According to a first aspect of the present disclosure, a rack system for a vehicle is provided. The rack system including at least one guide rail fixable to at least one vehicle structure of the vehicle within a rear storage compartment of the vehicle, and at least two racks slidingly supported by the at least one guide rail back and forth in a lateral or longitudinal direction of the vehicle and arranged in series to each other with respect to the at least one guide rail.

According to a second aspect of the present disclosure, a rack system for a commercial vehicle is provided. The rack system including at least one guide rail fixable to at least one vehicle structure of the commercial vehicle within a rear storage compartment of the commercial vehicle, at least two racks slidingly supported by the at least one guide rail back and forth in a lateral or longitudinal direction of the commercial vehicle and arranged in series to each other with respect to the at least one guide rail, and at least one electrically controllable actuator for slidingly moving the at least two racks along the at least one guide rail. The rack system also includes at least one sensor unit for detecting a current lateral inclination state of the commercial vehicle, at least one electronic control unit suitable to control the at least one electronically controllable actuator according to the current lateral inclination state of the commercial vehicle, so that the lateral inclination of the commercial vehicle becomes minimal or about zero, and at least one fixing unit for each rack for temporary fixing the respective rack selectively in one of several fixing positions disposed along the at least one guide rail by fixing the respective rack to the at least one guide rail and/or to the at least one vehicle structure.

According to a third aspect of the present disclosure, a commercial vehicle is provided including a rear load opening, a rear storage compartment, at least one vehicle structure, at least one guide rail fixable to the at least one vehicle structure within the rear storage compartment, and at least two racks slidingly supported by the guide rail back and forth in a lateral or longitudinal direction of the commercial vehicle and arranged in series to each other with respect to the at least one guide rail, wherein the rack system is accessible through the rear load opening.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1a is a schematic top view of a commercial vehicle equipped with a rack system, according to one embodiment;

FIG. 1B is a schematic top view of the commercial vehicle shown in FIG. 1a with the rack system in a balanced loading state;

FIG. 2 is a schematic top view of the commercial vehicle shown in FIGS. 1a and 1b with the rack system further adjusted for clamping;

FIG. 3 is a block diagram illustrating a controller unit for controlling the rack system, according to one example.

### DETAILED DESCRIPTION OF PREFERRED EMBODIMENTS

In the various figures, the same parts are always provided with the same reference signs, which is why they are generally described only once.

Embodiments of the disclosure are described hereinafter. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications.

Various combinations and modifications of the features consistent with the teachings of this disclosure, however, could be desired for particular applications or implementations.

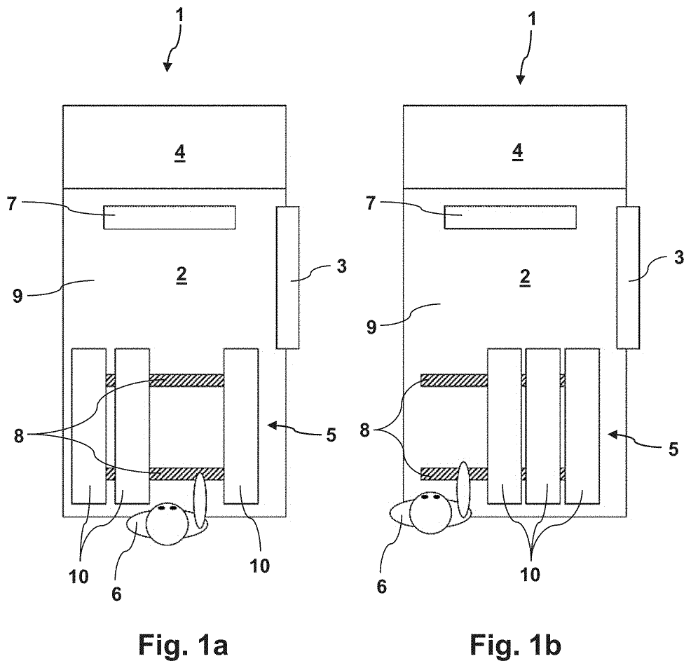

FIG. 1a shows a schematic top view of an embodiment of a commercial vehicle 1, such as a van, according to one embodiment. The commercial vehicle 1 has a rear storage compartment 2 that can be closed at its rear end by two doors (not shown) and is laterally closed by a sliding door 3. The commercial vehicle 1 further comprises a driver cabin 4 in front of the rear storage compartment 2.

The commercial vehicle 1 comprises a rack system 5 being accessible for a user 6 through a rear load opening (not shown) of the commercial vehicle 1. The rack system 5 mainly extends between the rear load opening and the sliding door 3. In the front part of the rear storage compartment 2 there is a fixed rack 7. It should be appreciated that the rack system 5 may be employed on other types of motor vehicles, such as a truck, a SUV or a tractor trailer, for example.

The rack system 5 comprises two guide rails 8 fixed to a floor 9 of the rear storage compartment 2 of the commercial vehicle 1. The guide rails 8 are arranged parallel to each other and laterally spaced from each other. The guide rails 8 extend in the lateral direction of the commercial vehicle 1.

Furthermore, the rack system 5 comprises three racks 10 slidingly supported by the guide rails 7 back and forth in the lateral direction of the commercial vehicle 1.

Moreover, the rack system 5 comprises at least one at least one fixing unit for each rack 10 for temporary fixing the respective rack 10 selectively in one of several fixing positions disposed along the guide rails 8 by fixing the respective rack 10 to the guide rails 8 and/or to the floor 9. The respective fixing unit can be self-locking and/or manually operatable and/or electromechanically operatable.

Additionally, the rack system 5 may comprise at least one manually operatable actuation unit for each rack 10 for moving the respective rack 10 along the guide rails 8, wherein the actuation unit may comprise at least one carrying wheel arranged at the bottom of the respective rack 10 and at least one manually operatable drive unit arranged on the respective rack 10 for driving the carrying wheel, and wherein the drive unit may comprise at least one manually operatable actuation element arranged on a side of the respective rack 19 being accessible through the rear opening of the rear storage compartment 2.

Alternatively, the rack system may comprise at least one electromechanical actuation unit for each rack 10 for moving the respective rack 10 along the guide rails 8.

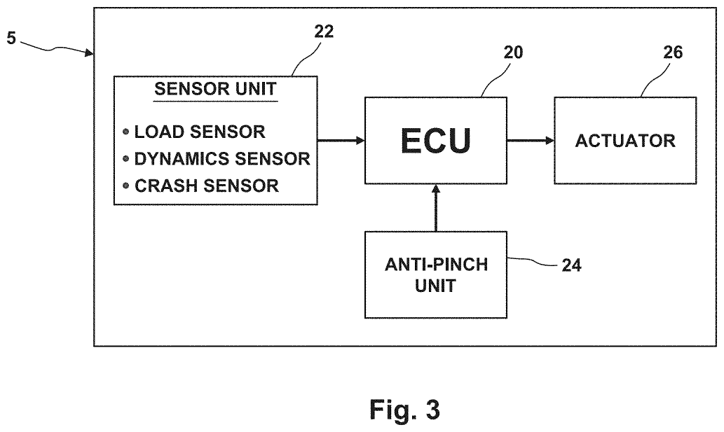

Moreover, the rack system 5 may comprise at least one electrically controllable actuator 26 for slidingly moving the rack 10 along the guide rails 8, at least one sensor unit 22 for detecting a current lateral inclination state of the commercial vehicle 1, and at least one electronic control unit (ECU) 20 suitable to control the actuator 26 according to the current lateral inclination state of the commercial vehicle 1, so that the lateral inclination of the commercial vehicle 1 becomes minimal or about zero. For this, the sensor unit 22 may comprise at least one load sensor, at least one dynamics sensor, and/or at least one crash sensor as shown in FIG. 3.

Further, the rack system 5 may comprise at least one anti-pinch unit 24 connected with the ECU 20.

FIG. 1B shows a further schematic top view of the commercial vehicle 1 shown in FIG. 1a in a balanced loading state. The state shown in FIG. 1B emanates from the state shown in FIG. 1a by a lateral displacement of the two racks 10 arranged on the left side in FIG. 1a. Therefore, another one of the racks 10 is accessible for the user 6.

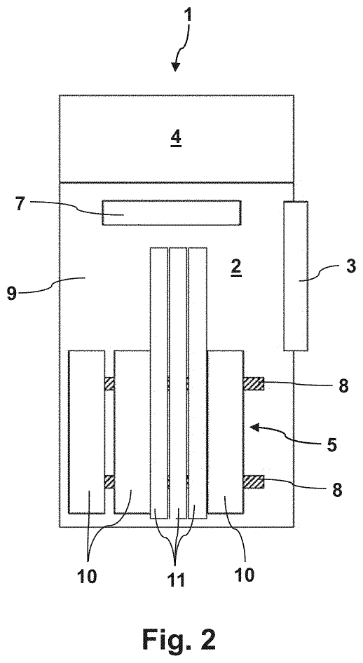

FIG. 2 shows a further schematic top view of the commercial vehicle 1 shown in FIGS. 1a and 1b. In FIG. 2 two racks 10 are additionally used to clamp three wooden posts 11 between these racks 10.

It should be noted that the features and measures listed individually in the following description can be combined with each other in any technically useful manner and show further embodiments of the disclosure. The following description additionally characterizes and specifies the rack system and commercial vehicle, in particular in connection with the figures.

According to the disclosure, by moving the racks relative to each other, the user can get access to each of the individual racks. This creates a unique solution, where a lot of rack space is created in a small volume of the rear storage compartment, optimizing the utilization rate of the commercial vehicle, and maximizing the efficiency of the user's business. Additionally, the rack system allows for the vehicle to be configured to leave a lot of floor space in the rear storage compartment for large items that can be positioned at the sliding door, for example. The rack system can be formed so that a space between the adjacent racks moved away from each other in opposite directions could be large enough for a user to walk through, for example, to the front part of the rear storage compartment. Additionally, the rack system can be formed so that, if all racks are moved to one side, a path can be on the other side of the racks where the user could walk through, for example, to the front part of the rear storage compartment. The number of racks of the rack system can be chosen depending on the required rack depth and the dimensions and amount of the cargo to be carried with the commercial vehicle. Therefore, the disclosure provides a more efficient way of offering rack space in the commercial vehicle to get a better trade-off between the amount of racks and space for other items, to maximize the utilization rate of a rear storage compartment of the commercial vehicle.

The racks could also be used and positioned to retain larger pieces of cargo between them. For example, for they could be used to clamp and therefore retain longer tubes or wooden posts.

The guide rail can be fixed to a floor structure of the rear storage compartment of the commercial vehicle, for example. The rack system may comprise two or more guide rails arranged parallel to each other and laterally spaced from each other in the longitudinal or lateral direction of the commercial vehicle.

For slidingly supporting the racks by the guide rail back and forth in a lateral or longitudinal direction of the commercial vehicle each rack may comprise at least one carriage slidably connecting the rack with the guide rail. Therefore, the respective rack and the guide rail may create a sliding guide. Alternately, the respective rack and the guide rail may create rolling element guide. The racks extend in the longitudinal or lateral direction of the commercial vehicle. Additionally, at least one of the racks may at least partly be extractable in the longitudinal or lateral direction of the vehicle, i.e., in a direction laterally to the guide rail, to be placed at least partly outside the rear storage compartment. The racks can be moved independently.

Another advantage of the rack system is that a loading of the commercial vehicle having a rear storage compartment can be laterally balanced by temporary fixing each rack selectively in one of several fixing positions disposed along the guide rail by fixing the respective rack to the guide rail and/or to the vehicle structure. Through this, the lateral weight distribution of the loaded commercial vehicle can be optimized. This advantage can be achieved by mounting the at least one guide rail in such a way that it extends in the lateral direction of the commercial vehicle.

Conventionally, there is often an uneven lateral weight distribution of a loaded commercial vehicle leading to one side being more loaded than the other side, wherein the commercial vehicle is leaning over to that side that is loaded more. This leads to uneven wear and tear of commercial vehicle components, like tires, and to uneven handling characteristics of the commercial vehicle. These disadvantages could also be minimized or eliminated by the use of the rack system.

The simplest way to achieve the load balancing according to one embodiment is a manual actuation of each rack, either by direct manual actuation of the rack or by indirect manual actuation on the rack by use of a mechanical actuation device of any kind. Through this, a user can move and afterwards fix the racks in that positions of the several fixing positions disposed along the guide rail that seem to the user to cause an optimal lateral weight distribution.

According to an advantageous embodiment, the rack system includes at least one fixing unit for each rack for temporary fixing the respective rack selectively in one of several fixing positions disposed along the guide rail by fixing the respective rack to the guide rail and/or to the vehicle structure. Through this, each rack can be secured in one of several positions so that, when driving a corresponding commercial vehicle, a movement of the racks is reliably prevented.

According to a further advantageous embodiment the fixing unit is self-locking and/or manually operatable and/or electromechanically operatable. The respective fixing unit can be a mechanical unit that can be operated manually. Alternatively, the respective fixing unit can be an electromechanical unit that can be activated automatically. The fixing unit, for example, can be formed like a fixing unit of a conventional adjustment device for back and forth adjustment of a vehicle, i.e., the respective rack can be fixed to the guide rail at certain fixing positions arranged at equal distances from each other.

According to a further advantageous embodiment the rack system includes at least one manually operatable actuation unit for each rack for moving the respective rack along the guide rail, wherein the actuation unit comprises at least one carrying wheel arranged at the bottom of the respective rack and at least one manually operatable drive unit arranged on the respective rack for driving the carrying wheel, and wherein the drive unit comprises at least one manually operatable actuation element arranged on a side of the respective rack being accessible through a rear opening of the rear storage compartment. Through this, the rack system can be formed like a conventional library system having a manually operatable actuation element in the form of a wheel or the like for each rack to drive the respective rack along the guide rail. By actuation, for example turning, the manually operatable actuation element the carrying wheel is driven so that the respective rack is pulled be means of the rack along the guide rail, wherein the carrying wheel can contact the guide rail and/or the floor of the rear storage compartment. Any kind of transmission can be used to transmit a force from the manually operatable actuation element of the respective rack to the carrying wheel of this rack.

According to a further advantageous embodiment the rack system includes at least one electromechanical actuation unit for each rack for moving the respective rack along the guide rail. Therefore, a user doesn't have to pull the racks manually. Instead, the racks can be moved automatically when the user operates a corresponding operation unit connected with the electromechanical actuation unit, for example a unit with switches, a touchscreen or else.

According to a further advantageous embodiment the rack system includes at least one electrically controllable actuator for slidingly moving said rack along the guide rail, at least one sensor unit for detecting a current lateral inclination state of the commercial vehicle, and at least one electronic control unit suitable to control the actuator according to the current lateral inclination state of the commercial vehicle, so that the lateral inclination of the commercial vehicle becomes minimal or about zero. To achieve this embodiment the guide rail is mounted in such a way that it extends in the lateral direction of the commercial vehicle. The electrically controllable actuator may be an electromechanical actuator with or without a transmission. The electrically controllable actuator can act like a conventional electronic adjustment of memory vehicle seats. The sensor unit may be suitable for determining the current lateral imbalance of the loaded commercial vehicle and/or the lateral position of the center of mass of the loaded commercial vehicle. The electronic control unit controls the electrically controllable actuator until the commercial vehicle is laterally balanced as good as possible.

According to a further advantageous embodiment the sensor unit includes at least one load sensor, at least one dynamics sensor, and/or at least one crash sensor. The dynamics sensor can be an anti-lock braking system (ABS) sensor.

According to a further advantageous embodiment the rack system includes at least one anti-pinch unit connected with the control unit. Through this, there can be provided a pinch recognition, so that any motion of the rack can be stopped immediately when it is sensed that there is too much resistance to the movement of the rack. The pinch-recognition unit may have at least one sensor or may be formed to determine the current resistance value from current electric characteristics of the electrically controllable actuator. Alternatively, the anti-pinch unit can be integrated in the electronic control unit.

According to the disclosure a commercial vehicle includes at least one rack system according to one of the preceding embodiments or a combination of at least two of these embodiments with each other, wherein the rack system is accessible through a rear load opening of the commercial vehicle.

The advantages mentioned above with reference to the rack system are correspondingly associated with the commercial vehicle. The racks can be located in a part of the rear storage compartment that is arranged between the rear opening of the rear storage compartment and the lateral sliding door.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A rack system for a vehicle, the rack system comprising:
at least one guide rail fixable to at least one vehicle structure of the vehicle within a rear storage compartment of the vehicle; and
at least two racks slidingly supported by the at least one guide rail back and forth in a lateral or longitudinal direction of the vehicle and arranged in series to each other with respect to the at least one guide rail.

2. The rack system according to claim 1 further comprising at least one fixing unit for each of the at least two racks for temporary fixing the respective rack selectively in one of several fixing positions disposed along the at least one guide rail by fixing the respective rack to the at least one guide rail and/or to the at least one vehicle structure.

3. The rack system according to claim 2, wherein the at least one fixing unit is self-locking and/or manually operatable and/or electromechanically operatable.

4. The rack system according to claim 1 further comprising at least one manually operatable actuation unit for each rack for moving the respective rack along the guide rail, wherein the at least one manually operatable actuation unit comprises at least one carrying wheel arranged at the bottom of the respective rack and at least one manually operatable drive unit arranged on the respective rack for driving the carrying wheel, and wherein the at least one manually operatable drive unit comprises at least one manually operatable actuation element arranged on a side of the respective rack being accessible through a rear opening of the rear storage compartment.

5. The rack system according to claim 1 further comprising at least one electromechanical actuation unit for each rack for moving the respective rack along the at least one guide rail.

6. The rack system according to claim 1 further comprising:
at least one electrically controllable actuator for slidingly moving the at least one rack along the at least one guide rail;
at least one sensor unit for detecting a current lateral inclination state of the vehicle; and
at least one electronic control unit suitable to control the at least one electronically controllable actuator according to the current lateral inclination state of the vehicle, so that the lateral inclination of the vehicle becomes minimal or about zero.

7. The rack system according to claim 6, wherein the at least one the sensor unit comprises at least one load sensor, at least one dynamics sensor, and/or at least one crash sensor.

8. The rack system according to claim 6 further comprising at least one anti-pinch unit coupled with the at least one electronic control unit.

9. The rack system according to claim 1, wherein the vehicle is a commercial vehicle.

10. A rack system for a commercial vehicle, the rack system comprising:
at least one guide rail fixable to at least one vehicle structure of the commercial vehicle within a rear storage compartment of the commercial vehicle;
at least two racks slidingly supported by the at least one guide rail back and forth in a lateral or longitudinal direction of the commercial vehicle and arranged in series to each other with respect to the at least one guide rail;
at least one electrically controllable actuator for slidingly moving the at least two racks along the at least one guide rail;
at least one sensor unit for detecting a current lateral inclination state of the commercial vehicle;
at least one electronic control unit suitable to control the at least one electronically controllable actuator according to the current lateral inclination state of the commercial vehicle, so that the lateral inclination of the commercial vehicle becomes minimal or about zero; and
at least one fixing unit for each rack for temporary fixing the respective rack selectively in one of several fixing positions disposed along the at least one guide rail by fixing the respective rack to the at least one guide rail and/or to the at least one vehicle structure.

11. The rack system according to claim 10, wherein the at least one fixing unit is self-locking and/or manually operatable and/or electromechanically operatable.

12. The rack system according to claim 10 further comprising at least one manually operatable actuation unit for each rack for moving the respective rack along the at least one guide rail, wherein the at least one manually operatable actuation unit comprises at least one carrying wheel arranged at the bottom of the respective rack and at least one manually operatable drive unit arranged on the respective rack for driving the carrying wheel, and wherein the at least one manually operatable drive unit comprises at least one manually operatable actuation element arranged on a side of the respective rack being accessible through a rear opening of the rear storage compartment.

13. The rack system according to claim 10 further comprising at least one electromechanical actuation unit for each rack for moving the respective rack along the at least one guide rail.

14. The rack system according to claim 10, wherein the at least one the sensor unit comprises at least one load sensor, at least one dynamics sensor, and/or at least one crash sensor.

15. The rack system according to claim 10 further comprising at least one anti-pinch unit connected with the at least one electronic control unit.

16. A commercial vehicle comprising:
a rear load opening;
a rear storage compartment;
at least one vehicle structure;
at least one guide rail fixable to the at least one vehicle structure within the rear storage compartment; and
at least two racks slidingly supported by the guide rail back and forth in a lateral or longitudinal direction of the commercial vehicle and arranged in series to each other with respect to the at least one guide rail, wherein the rack system is accessible through the rear load opening.

17. The commercial vehicle according to claim 16 further comprising at least one fixing unit for each rack for temporary fixing the respective rack selectively in one of several fixing positions disposed along the at least one guide rail by fixing the respective rack to the at least one guide rail and/or to the at least one vehicle structure.

18. The commercial vehicle according to claim 16 further comprising at least one manually operatable actuation unit for each rack for moving the respective rack along the at least one guide rail, wherein the at least one manually operatable actuation unit comprises at least one carrying wheel arranged at the bottom of the respective rack and at least one manually operatable drive unit arranged on the respective rack for driving the carrying wheel, and wherein the at least one manually operatable drive unit comprises at least one manually operatable actuation element arranged on a side of the respective rack being accessible through the rear opening of the rear storage compartment.

19. The commercial vehicle according to claim 16 further comprising:
at least one electrically controllable actuator for slidingly moving the at least two racks along the at least one guide rail;
at least one sensor unit for detecting a current lateral inclination state of the commercial vehicle; and
at least one electronic control unit suitable to control the at least one electronically controllable actuator according to the current lateral inclination state of the commercial vehicle, so that the lateral inclination of the commercial vehicle becomes minimal or about zero.

20. The commercial vehicle according to claim 19 further comprising at least one anti-pinch unit coupled with the at least one electronic control unit.
